(19) United States
(12) Patent Application Publication
(10) Pub. No.: US 2018/0044906 A1
(43) Pub. Date: Feb. 15, 2018

(54) Anti-Vermin Barrier

(71) Applicant: McAlpine & Co. Ltd., Glasgow, Strathclyde (GB)

(72) Inventor: James Edward McAlpine, Paisley (GB)

(21) Appl. No.: 15/552,795

(22) PCT Filed: Feb. 23, 2016
(86) PCT No.: PCT/GB2016/050448

§ 371 Date: Aug. 22, 2017

(30) Foreign Application Priority Data
Feb. 23, 2015 (GB) 1502942.4

(51) Int. Cl. E03F 7/06

(52) U.S. Cl. CPC E03F 7/06; A01M 29/30

(57) ABSTRACT

An apparatus (10; 110) for preventing vermin or rodent (24) access to buildings through drainage conduits. The apparatus (10; 110) comprises: a duct (12) defining a flowpath and a barrier (16; 116) which prevents access to vermin or rodents (24) through the drainage conduit. The barrier (16; 116) includes a protective structure (165) to deter vermin gnawing the through the barrier (16; 116). The barrier (16; 116) is movable between a flowpath closed position in which the flowpath is substantially closed and a flowpath open position in which the flowpath is substantially open. The barrier (16) is biased to the flowpath closed position by a threshold force. As such the barrier (16) is movable to the flowpath open position upon application of a force greater than the threshold force. The threshold force is sufficient to maintain the barrier (16; 116) in the flowpath closed position under its own weight.

### FIELD OF THE INVENTION

The present invention belongs to the technical field of vermin control. Particular embodiments of the present invention find application in the construction industry, more specifically in the provision of drainage and sewerage installations.

### BACKGROUND TO THE INVENTION

Vermin, such as rodents and more particularly rats and mice, are animals that are disease carriers as well as being repulsive to many people. A number of devices have been conceived to avoid rodent access to habitable spaces. For example grids, fences, etc. A singular problem is encountered in drainage and sewerage installations, where there has to be a flow path substantially free of obstacles where solids entrained in the drainage flow can become trapped and form a plug. To solve the problem of both keeping a free flow path and prevent rodent intrusion, anti-rodent barriers have been developed that can be installed in drain and sewer lines. A common technique used in such anti-rodent barriers is the provision of a hinged plastic flap that is placed covering the flow path and can only be opened in one way, such that rodents cannot pass through it upstream but the flap opens and offers no resistance to downstream flow.

These anti-rodent barriers present the problem that rodents instinctively gnaw on the plastic flap and eventually gain access through the barrier over time.

### SUMMARY OF THE INVENTION

According to the first aspect of the invention there is provided an apparatus for preventing vermin access to buildings through drainage conduits, the apparatus comprising:

a duct defining a flow path, and

a barrier, the barrier being movable between a flowpath closed position in which the flowpath is substantially closed and a flowpath open position in which the flowpath is substantially open, the barrier being biased to the flowpath closed position by a threshold force, the barrier being movable to the flowpath open position upon application of a force greater than the threshold force and the threshold force being sufficient to maintain the barrier in the flowpath closed position under its own weight

wherein the barrier comprises a protective structure to deter vermin gnawing the barrier through.

In order to clarify the ambit of the invention, the barrier is movable between one closed position and one open position, that means it is only movable between two extreme points, one in which the barrier closes the flowpath and one in which the barrier opens the flowpath. This means that movement towards any position other than those between these two extreme points is not possible, or in shorter terms, the barrier opens in one-way only.

In at least one embodiment of the present invention by providing a protective structure to the barrier, gnawing a hole through the barrier by vermin is prevented and therefore they cannot gain access beyond the barrier. Additionally the protected barrier is light enough so that the barrier can maintain its closed position despite its own weight, when the apparatus is installed in an inclined or vertical position and the threshold force is small enough so that the barrier can be moved to a flowpath open position by a small liquid discharge when the barrier is in a substantially horizontal position.

The barrier may comprise a matrix in which the protective structure is at least partially embedded. In at least one embodiment of the present invention the matrix encompasses the majority of the area of the barrier whereas the protective structure comprises gaps or holes so that the barrier weight can be minimised in order to reduce the threshold force as much as possible while maintaining the impenetrability of the barrier.

The protective structure may comprise a plurality of intersecting formations integrated in the barrier.

The protective structure may comprise spiky formations. In at least one embodiment of the present invention by providing a protective structure comprising spiky formations, rodents are deterred from approaching and gnawing the barrier because they are pricked by the spiky formations.

The protective structure may comprise a soft elastic surface. In at least one embodiment of the present invention a barrier comprising a soft elastic surface protection prevents rodent gnawing of the barrier because the soft material dampens the rodent's bite and prevents it from being eroded by the rodent's teeth.

The protective structure may comprise a hairy or fibrous surface. In at least one embodiment of the present invention a hairy or fibrous surface deters vermin from gnawing that surface because their teeth become entangled or because vermin feel unpleasant gnawing on it.

The protective structure may comprise an electric conductor material connected to an electric current source. In at least one embodiment of the present invention a protective structure comprising an electric conductor material connected to an electric current source deters vermin gnawing the barrier because they become scared of touching the electrified barrier.

The protective structure may comprise a vermin deterrent substance. In at least one embodiment of the present invention a protective structure comprises a substance that deters vermin from approaching the barrier by releasing the deterrent substance into the surrounding atmosphere. In another embodiment, the protective structure comprises a deterrent substance that tastes unpleasant to vermin and causes vermin to cease and desist gnawing on the barrier.

The protective structure may comprise a mesh structure. In at least one embodiment of the present invention a mesh structure can provide impenetrability to the whole barrier without adding excessive weight to it.

The mesh structure may be at least partially embedded in the matrix. In at least one embodiment of the present invention a mesh structure partially embedded in the matrix does not need additional attachments means to attach it to the barrier.

The protective structure may comprise a mesh of a tougher material than the matrix. In at least one embodiment of the present invention by providing a mesh of a tougher material than the matrix, vermin gnawing on the barrier get confused and deterred from further gnawing on the barrier.

The mesh structure may comprise a metallic mesh. In at least one embodiment of the present invention a metallic mesh is a low cost protective structure that can be easily incorporated into a matrix and prevent vermin gnawing through it.

The mesh structure may comprise a high-strength fibre mesh. In at least one embodiment of the present invention a high-strength fibre mesh can also confer impenetrability to the barrier against vermin gnawing.

The high-strength fibre mesh may comprise a nylon mesh.

The matrix may comprise a polymeric matrix. In at least one embodiment of the present invention a polymeric matrix can be easily mass-produced, can be used to embed a mesh structure and cover a wide flowpath without encompassing excessive weight.

The barrier may comprise one or more members. In at least one embodiment of the present invention by providing a barrier comprising one or more members, the threshold force required to keep the barrier closed under its own weight can be distributed among the one or more members and consequently the force needed to open the barrier when the apparatus is in a substantially horizontal position is also reduced.

In some embodiments, there are a plurality of barrier members, such as flaps, that cooperatively open and close the flow path. In other embodiments there is one single barrier member, such as a flap, that opens and closes the flowpath.

The/each barrier member may be hinged to the duct. In at least one embodiment of the present invention hinging the/each barrier member to the duct is an easy and convenient way to enable movement of the/each barrier member between a flow path closed and a flowpath open position.

The/each barrier member may comprise a thin element. In at least one embodiment of the present invention thin members are suitable because they have large areas and small thicknesses so that their weight per unit area is small and therefore the threshold force to keep the/each barrier member in a closed position is small.

The/each barrier member may comprise a curved flap. Curved flaps are suitable for opening and closing the flowpath from within the duct.

In some embodiments the barrier is located at an end of the duct.

In other embodiments the barrier is located within the duct.

The barrier may define an area larger than the cross-sectional area of an adjacent section of the duct. In at least one embodiment of the present invention by providing a barrier that encompasses an area larger than the cross-sectional area of an adjacent section of the duct, the flow path can be closed when the barrier is moved and pressed towards the adjacent duct section of smaller cross-sectional area and the flow path can be opened when the/each barrier moves away from the adjacent section of smaller cross-sectional area.

The barrier may sealingly engage the duct when the barrier is in the flowpath closed position. In at least one embodiment of the present invention when the barrier sealingly engages the duct in the closed position, the apparatus can also prevent odours from migrating towards the interior of buildings.

The barrier may comprise a soft elastic edge. In at least one embodiment of the present invention a barrier with a soft elastic edge sealingly engages with ease the duct walls.

The apparatus may comprise at least one biasing element. The at least one biasing element imparts the threshold force upon the/each barrier member to maintain the flow path closed when there is no force acting on the/each barrier member, apart from its weight.

The/each biasing element may connect the/each barrier member to the duct.

The/each biasing element may comprise a resilient material.

The/each biasing element may comprise an elastic material.

The/each biasing element may comprise a metallic resilient element.

The/each biasing element may comprise a spring.

The duct may comprise sections with different internal cross-sectional areas.

The duct may comprise internal formations to prevent the/each barrier to open in an undesired direction. In at least one embodiment of the present invention a duct with different internal cross-sectional areas and/or formations provides kinks or edges that prevent the barrier to open in an undesired direction and thus prevents vermin access to the drainage conduit beyond the point where the barrier is located.

The duct may comprise connecting portions. In at least one embodiment of the present invention a duct comprising connecting portions is easily installed or inserted in a drainage line.

The duct may be made of a mouldable material. In at least one embodiment of the present invention a duct made with a mouldable material is suitable to be mass-produced.

The duct may comprise a section with a smooth interior adjacent to the barrier to prevent an easy approach of vermin to the barrier when the apparatus is inclined or in a vertical position. In at least one embodiment of the present invention a smooth interior facilitates that vermin slide and find difficulty in supporting themselves in position for gnawing the barrier.

According to a second aspect of the invention there is provided an apparatus for preventing vermin access to buildings through drainage conduits, the apparatus comprising:

a duct defining a flow path, and

a membrane barrier, the membrane barrier being movable between a flow path open position in which the flowpath is substantially open and a flowpath closed position in which the flowpath is substantially closed, the membrane barrier being biased to the flowpath closed position, the membrane barrier being movable to the flowpath open position upon application of a threshold force and the duct being configured to prevent the membrane barrier from moving to an open position in which the membrane barrier is partially reversed

wherein the membrane barrier comprises a reinforcing structure to prevent and/or deter vermin gnawing the membrane barrier through.

In at least one embodiment of the present invention the membrane barrier can be shaped as a duck bill valve so that it opens and closes and is biased into a closed position and opens when there is a drain stream flowing through it but cannot open towards the opposite direction by reversing the membrane. The reinforcing structure prevents rodents gnaw access holes through the membrane, therefore the apparatus can be used to prevent liquid backflush, odours migrating upstream the drain piping and/or vermin accessing building interiors through the drains.

In one embodiment the reinforcing structure is a mesh of nylon thread embedded in the membrane.

Any aspect of the invention may encompass any features of any other aspect of the invention and are not repeated here for brevity.

### BRIEF DESCRIPTION OF THE DRAWINGS

The present invention will be more clearly explained in the following paragraphs in which embodiments and features of the prior art and the present invention will be described with reference to the following drawings, in which:

FIG. 1 represents an anti-vermin barrier typically encountered in the prior art in a flowpath open position.

FIGS. 2a and 2b represent an anti-vermin barrier typically encountered in the prior art in a flowpath closed position.

FIG. 3 shows an embodiment of the present invention in which the barrier comprises spiky formations.

FIG. 4 shows another embodiment of the present invention in which the barrier is electrified.

FIG. 5 shows another barrier of another embodiment of the present invention, in which the barrier comprises a protective metallic mesh.

### DETAILED DESCRIPTION OF THE DRAWINGS

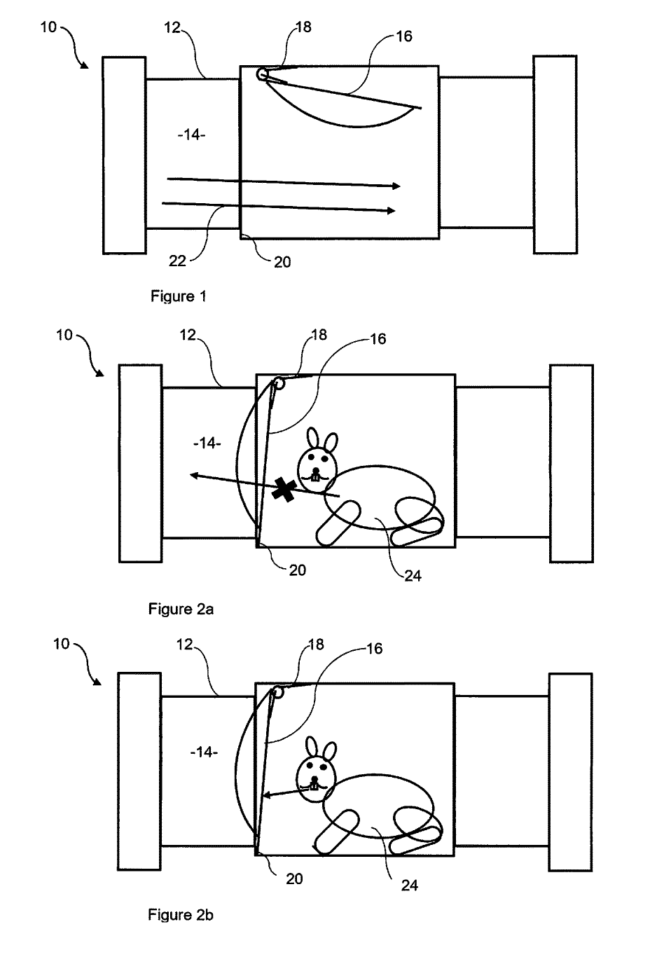

FIG. 1 shows an apparatus for preventing rodent access through a drain pipeline, indicated generally by reference numeral 10. The apparatus 10 comprises a duct 12 which defines a flowpath 14. The apparatus further comprises a barrier 16 which is movable between a flowpath open position and a flowpath closed position, which is shown in FIG. 1.

The apparatus 10 comprises a biasing element 18 which keeps the barrier in a closed position by pressing the barrier against a step 20 in the duct 12 adjacent to the barrier 16, in the absence of any force acting on it, except its own weight. The barrier 16 is hinged onto the duct wall on one side of the barrier.

FIG. 1 shows a drain stream 22 that circulates thought the duct 12 and moves the barrier into a flowpath open position.

FIG. 2a shows the same apparatus of FIG. 1, but this time the barrier 16 is in a flowpath closed position, because there is not force acting on it. A rodent 24 has crawled into the draining system and now faces the barrier 16, which prevents its further access into the draining system.

FIG. 2b shows is meant to indicate that the rodent 24 instinctively will try to gain further access, either because it sense warmth, light or pleasant smells coming from upstream, by gnawing the barrier. The rodent 24 may try several times, even in different days and upon persistent gnawing could finally create a hole through the barrier.

A hole in the barrier 16 presents problems irrespective of the size of the hole, because a liquid discharge with entrained solids could potentially not open the barrier, because the liquids can drain through the hole and leave the solids upstream of the barrier. This is highly undesirable, as it can create a clog and/or a point where bad smells are produced.

Additionally, the rodent 24 can eventually gain access through the barrier 16 if the hole is large enough, which is also to be avoided.

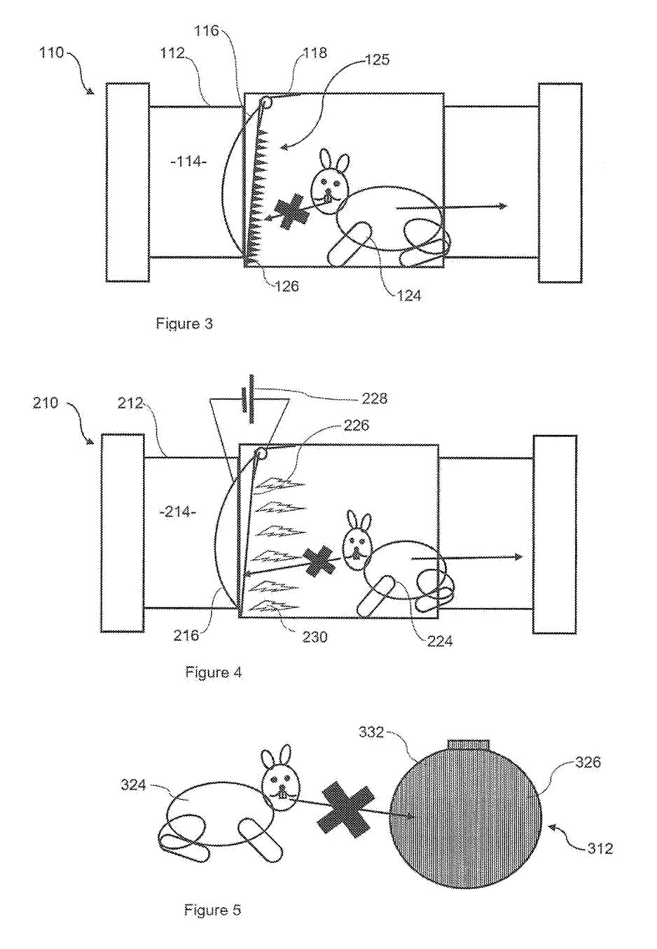

FIG. 3 shows an apparatus 110 according to an embodiment of the present invention. Apparatus 110 is similar to apparatus 10 and similar features are indicated with like numerals incremented by 100. The barrier 116 of apparatus 110 further comprises a protective structure 165 to deter vermin gnawing the barrier 116 through. In this embodiment, the protective structure 165 comprises an array of spiky formations 166 distributed on the barrier 116 surface, so that when any animal tries to approach the barrier, it gets pricked and causes it to desist in gnawing the barrier through and/or going further upstream, thus protecting and maintaining the integrity of the barrier 116. It will be noticed that the spiky formations 166 can be made of a light material, such as plastic, provided that the spikes are sharp enough to prickle vermin approaching the barrier 116.

FIG. 4 shows an apparatus 210 according to another embodiment of the present invention. Apparatus 210 is similar to apparatus 10 and similar features are indicated with like numerals incremented by 200. The barrier 216 of apparatus 210 comprises a layer of a conductor material 226 connected to an electrical current source 228, so that the barrier 216 is electrified, as indicated by small lightning symbols 230. In this case, any animal trying to access the interior of a building through the drains, upon contact of the barrier 216, senses small electrical shocks which causes vermin to desist in gnawing the barrier through and/or attempt to go beyond that point, therefore protecting and maintaining the integrity of the barrier.

FIG. 5 shows a barrier 316 which forms part of yet another embodiment of the present invention (not shown) similar to those shown before. In this embodiment, the barrier 316 comprises a protective metallic mesh 326 embedded in a polymeric matrix 332. Any animal that tries to gnaw the barrier 316 through, will feel the toughness of the metallic mesh 326 and this discourages any animal from further gnawing, perhaps by pain infringed by gnawing in such a hard element, thus protecting the integrity of the barrier 316.

It is hereby emphasized that is it is important for the invention to work also when the embodiments are installed in an inclined and vertical position and therefore, the barrier weight must be kept as light as possible, so that it can be biased in a closed position when installed vertically without using an excessive threshold force, because when installed horizontally the threshold force needs to be as small as possible, so that the barrier opens the flowpath with the smallest of discharges.

It is also to be highlighted that it is not necessary to hinge the barrier onto the duct because embodiments without hinges, similar to one-way check valves, are understood to fall within the scope of the invention, although not described herein.

Materials and dimensions can also be very different in different embodiments of the invention and are therefore not detailed herein because a person of ordinary skill would be able to build suitable embodiments without having this information detailed.

1.-46. (canceled)

47. An apparatus for preventing vermin access to buildings through drainage conduits, the apparatus comprising:
a duct defining a flowpath, and
a barrier member comprising a flap, operable to open and close the flowpath; and
at least one biasing element;
wherein the barrier member is movable between a flowpath closed position in which the flowpath is substantially closed and a flowpath open position in which the flowpath is substantially open, the barrier member being biased to the flowpath closed position by a threshold force, wherein the biasing element is operable to impart the threshold force upon the barrier member to maintain the flowpath closed position when there is no force acting on the barrier member; and
wherein the barrier member is movable to the flowpath open position upon application of a force greater than the threshold force and the threshold force being sufficient to maintain the barrier member in the flowpath closed position,
wherein the barrier member comprises a matrix and a protective structure at least partially embedded in the matrix, wherein the protective structure is operable to deter vermin gnawing through the barrier member.

48. The apparatus as claimed in claim 47, wherein the barrier member is movable between one fully closed position and one fully open position, wherein the barrier member is only movable between two extreme points, one in which the barrier member fully closes the flowpath and one in which the barrier member fully opens the flowpath.

49. The apparatus as claimed in claim 47, wherein the barrier member is configured to be lightweight, wherein the barrier member is light enough such that the barrier member can maintain a closed position despite its own weight, wherein, in use, when the apparatus is installed in an inclined or vertical position the threshold force is small enough so that the barrier member can be moved to the flowpath open position by a small liquid discharge when the barrier member is in a substantially horizontal position.

50. The apparatus as claimed in claim 47, wherein the matrix encompasses substantially whole surface area of the barrier member.

51. The apparatus as claimed in claim 50, wherein the protective structure comprises gaps or holes such that barrier member weight can be minimised.

52. The apparatus as claimed in claim 50, wherein the protective structure comprises a plurality of intersecting formations integrated in the barrier member.

53. The apparatus as claimed in claim 50, wherein the protective structure comprises spiky formations.

54. The apparatus as claimed in claim 47, wherein the protective structure comprises a soft elastic surface.

55. The apparatus as claimed in claim 47, wherein the protective structure comprises a hairy or fibrous surface.

56. The apparatus as claimed in claim 47, wherein the protective structure comprises an electric conductor material connected to an electric current source.

57. The apparatus as claimed in claim 47, wherein the protective structure comprises a vermin deterrent substance.

58. The apparatus as claimed in claim 57, wherein the vermin deterrent substance provides an aroma which is unpleasant to vermin and is operable to deter vermin from approaching the barrier member, wherein the aroma is released into surrounding atmosphere.

59. The apparatus as claimed in claim 57, wherein the deterrent substance comprises a taste, which is unpleasant to vermin thereby deterring vermin from gnawing the barrier member.

60. The apparatus as claimed in claim 47, wherein the protective structure comprises a mesh structure.

61. The apparatus as claimed in claim 60, wherein the mesh structure comprises tougher material than the matrix.

62. The apparatus as claimed in claim 47, wherein the barrier member is hinged to the duct.

63. The apparatus as claimed in claim 47, wherein the barrier member comprises a curved flap.

64. The apparatus as claimed in claim 47, wherein the duct comprises sections with different internal cross-sectional areas and wherein the barrier member defines an area larger than the cross-sectional area of an adjacent section of the duct.

65. The apparatus as claimed in claim 47, wherein the barrier member comprises a soft elastic edge operable, in use to seal against duct walls.

66. The apparatus as claimed in claim 47, wherein the biasing element comprises a spring.
